(19) United States
(12) Patent Application Publication
(10) Pub. No.: US 2007/0127846 A1
(43) Pub. Date: Jun. 7, 2007

(54) APPARATUS AND METHOD FOR SUB-PICTURE PROCESSING BY PERFORMING AT LEAST SCALING AND PIXEL DATA ENCODING

(76) Inventor: Yi-Kuo Wei, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/381,546

(22) Filed: May 4, 2006

Related U.S. Application Data
(60) Provisional application No. 60/597,535, filed on Dec. 7, 2005.

(51) Int. Cl. G06K 9/32

(52) U.S. Cl. 382/298

(57) ABSTRACT

A system for performing scaling on a sub-picture is disclosed. The system includes: a pixel data decoding module, for receiving encoded pixel data of the sub-picture and decoding the encoded pixel data to generate pixel data of the sub-picture; a scaling module, for receiving the pixel data of the sub-picture, setting a scaling factor according to the pixel data, and scaling the pixel data according to the scaling factor to generate scaled pixel data of a scaled sub-picture corresponding to the sub-picture; and a pixel data encoding module, for encoding the scaled pixel data to generate encoded scaled pixel data of the sub-picture.

### CROSS REFERENCE TO RELATED APPLICATIONS

This application claims the benefit of U.S. Provisional Application No. 60/597,535, which was filed on Dec. 7, 2005 and is included herein by reference.

### BACKGROUND

The advent of higher resolution technology such as HDTV (high definition television) means that significantly more detailed television pictures can be produced than before. HDTV improves over standard definition TV by increasing both the number of pixels at each horizontal scan line and the number of horizontal scan lines. When video data is received by a system for displaying, however, it is often received in a different format from that supported by the system, and needs to be scaled according to the resolution supported by the displaying device. In terms of up-scaling, new lines of pixels need to be added to a picture (field or frame) and new pixels need to be added to a horizontal scan line. In terms of down-scaling, some lines of pixels need to be discarded and some pixels at a scan line need to be discarded. Scaling devices utilize scaling factors to determine the final quantity and location of pixels.

A video data of a picture can be broken down into many sub-pictures, where each sub-picture has a different number of pixels. Therefore, when scaling sub-pictures, the scaling factor will vary for each sub-picture. As a result, a novel scaling hardware/firmware system to support a variable scaling factor is needed.

### SUMMARY

With this in mind, it is therefore an objective of the present disclosure to provide a firmware apparatus and hardware apparatus for scaling a sub-picture that support a variable scaling factor.

Briefly described, a first embodiment comprises: a pixel data decoding module, for receiving encoded pixel data of the sub-picture and decoding the encoded pixel data to generate pixel data of the sub-picture; a scaling module, for receiving the pixel data of the sub-picture, setting a scaling factor according to the pixel data, and scaling the pixel data according to the scaling factor to generate scaled pixel data of a scaled sub-picture corresponding to the sub-picture; and a pixel data encoding module, for encoding the scaled pixel data to generate encoded scaled pixel data of the sub-picture.

A second embodiment comprises: a run-length data decoding module, for receiving encoded run-length data of the sub-picture and decoding the encoded run-length data to generate run-length data of the sub-picture; a scaling module, for receiving the run-length data of the sub-picture, setting a scaling factor according to the run-length data, and scaling the run-length data according to the scaling factor to generate scaled run-length data of a scaled sub-picture corresponding to the sub-picture; and a run-length data encoding module, for encoding the scaled run-length data to generate encoded scaled run-length data of the sub-picture.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a video scaling system for scaling a video unit according to a first embodiment of the present invention.

FIG. 2 is a diagram of a video scaling system for scaling a video unit according to a second embodiment of the present invention.

### DETAILED DESCRIPTION

Certain terms are used throughout the following description and claims to refer to particular system components. As one skilled in the art will appreciate, consumer electronic equipment manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

Conceptually, the present disclosure works by decoding a data stream according to a specific compression scheme, determining the pixel information of the data stream, and using the pixel information of the original resolution format to generate pixel data of a desired resolution format. This is achieved by setting a first vector, obtained by utilizing a first algorithm. The first vector is then utilized by a second algorithm for setting a scaling factor, wherein the scaling factor can be varied according to the desired resolution format. The scaling factor is utilized in a software program to vary a sub-factor, wherein if the sub-factor fulfills a certain condition then a pixel will be output. In this way, the scaling factor is utilized to scale the data stream and the scaled data stream is then re-encoded according to the specific compression scheme.

Run-length data encoding and pixel data encoding are examples of lossless compression, where data can be reconstructed exactly, bit-for-bit. This means that the data can be encoded and decoded according to the lossless compression scheme and still maintain the same data, i.e. the same video information.

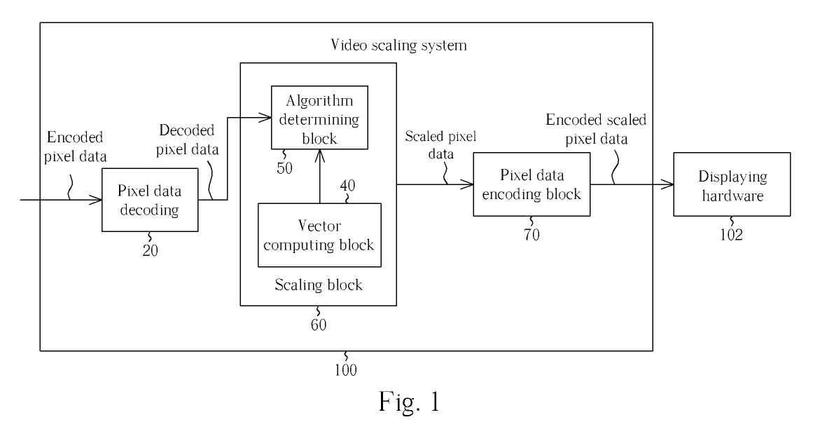

Please refer to FIG. 1. FIG. 1 is a diagram of a video scaling system 100 for scaling a video unit (e.g. a sub-picture) according to a first embodiment of the present invention. Please note that the components can be implemented by hardware or software—for convenience of illustration they are illustrated as block components—however, the video scaling system 100 is herein described with reference to the firmware system and the term ‘block’ is therefore replaced with the term ‘module’. The firmware system (i.e. the video scaling system 100) comprises a pixel data decoding module 20, coupled to a scaling module 60. The pixel data decoding module 20 receives encoded pixel data of a sub-picture and decodes the data to retrieve the original pixel data of the sub-picture. This pixel data is then input to the scaling module 60. The scaling module 60 comprises a vector computing module 40 for utilizing an algorithm to obtain a first vector. This vector is the ratio of a second video resolution format to a first video resolution format. The scaling module 60 also comprises an algorithm determining module 50. The first vector is input to the algorithm determining module 50, which utilizes an algorithm to determine a suitable scaling factor for the sub-picture. This is determined by dividing a scaling base (i.e. the number of pixels outputted in a clock cycle) by the first factor. The scaling module utilizes the scaling factor to selectively output pixels by setting a sub-factor, wherein if the sub-factor is below the scaling base then a pixel will be output, and if the sub-factor is above the scaling base then a pixel will not be output. The scaling factor is added to the sub-factor for controlling this operation.

This operation is illustrated below using pseudo code:

Initially sub-factor = 0
Pixel = Pixel_start
While (pixel<pixel_end)
{ if (sub-factor < 256)

{ output (pixel) }

sub-factor = sub-factor + scale factor;
if (sub-factor > 256)
{ sub-factor = sub-factor − 256; }
Next (pixel)
}

When a scaling down operation is performed, initially the sub-factor is set to zero. The scaling module determines if the sub-factor is less than the scaling base, for example 256, and if this is true then a first pixel will be output. A scaling factor is calculated, according to a required resultant definition format, and the scaling factor is added to the sub-factor. The scaling module then proceeds to a next pixel and determines if the new sub-factor is greater than the scaling base, i.e. greater than 256. If this is true the next pixel will not be output. The sub-factor will then be adjusted again, by subtracting the scaling base from the previous sub-factor, i.e. subtracting 256. The system then proceeds to a next pixel: if the new sub-factor is less than 256 the pixel will be output and a new sub-factor calculated; if the new sub-factor is greater than 256 the pixel will not be output, and a new sub-factor will be calculated by subtracting 256 from the previous value.

An scaling up operation is illustrated below using pseudo code:

Initially sub-factor = 0
Pixel = Pixel_start
While (pixel<pixel_end)
{

while (sub-factor < 256)
{

output (pixel);
sub-factor = sub-factor + scale factor;

}
sub-factor = sub-factor − 256;
Next (pixel)

When a scaling up operation is performed, the sub-factor is initially set to zero. The system proceeds to a first pixel, and the scaling module determines if the sub-factor is less than 256. If this condition is true then the pixel will be output. The scaling module then sets a scaling factor according to the required resultant definition format, and the scaling factor is added to the sub-factor. In this scaling operation, the system remains at the same pixel, and determines if the sub-factor is still less than 256. If this condition is true then the same pixel will be output again. If this condition is not true then the system will subtract 256 from the sub-factor and then proceed to a next pixel. In this manner the same pixel can be output a plurality of times according to the desired number of pixels in a final definition format.

Once the original pixel data is scaled according to the scaling factor it is then input to a pixel data encoding module 70. The pixel data encoding module 70 re-encodes the scaled pixel data and sends it to a hardware component (i.e. the displaying hardware 102), where it can be fully decoded and displayed. In this embodiment, the encoded scaled pixel data can be directly read by displaying hardware 102 for displaying the scaled sub-picture. It should be noted that the displaying hardware 102 shown in FIG. 1 includes all hardware components required to process the encoded scaled pixel data and display the scaled sub-picture.

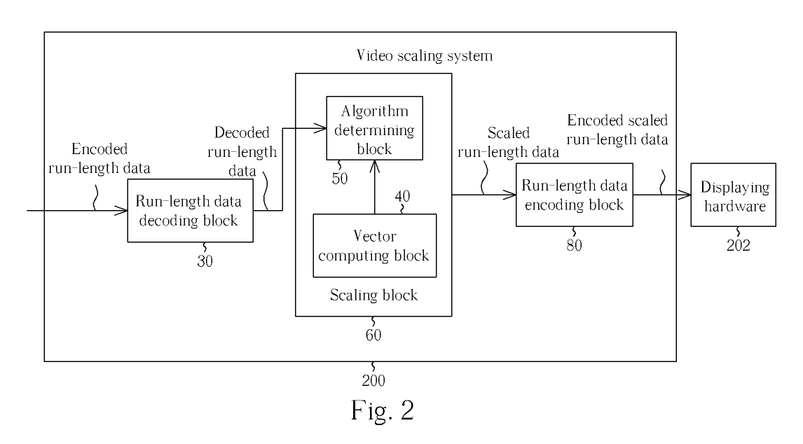

The present disclosure also supports performing scaling on data that is decoded according to other lossless compression schemes. A second example utilizing run-length data to perform the scaling algorithms is disclosed. Please refer to FIG. 2. FIG. 2 is a diagram of a video scaling system 200 for performing scaling on a video unit (e.g. a sub-picture) according to a second embodiment of the present invention. Similarly, the components shown in FIG. 2 can be implemented by hardware or software—for convenience of illustration they are illustrated as block components, however, the video scaling system 200 is herein described with reference to the firmware system and the term ‘block’ is therefore replaced with the term ‘module’. Please note that the operation is largely the same as the aforementioned video scaling system 100, however, in FIG. 2 the pixel data decoding module 20 is replaced by a run-length data decoding module 30, and the pixel data encoding module 70 is replaced by a run-length data encoding module 80. The run-length data decoding module 80 obtains information regarding the associated colors of each pixel of the sub-picture in terms of run-lengths. In this way, the scaling module 60 can determine the number of pixels in a present sub-picture. The scaling module 60 then inputs the run-length information to the algorithm determining module 50, which utilizes this information and the first vector determined by the vector computing module 40 to obtain the scaling factor. When the scaling operation is performed, the scaling module will selectively output pixels according to their colors—for example, if the decompressed data stream shows that there are five pixels having a color red, and the scaling factor is equal to two, then the scaling module will output the run of pixels twice so the encoding module will receive a run of ten pixels having a color red. Because the encoding module encodes the data according to the same compression scheme as the decoding module, a scaled picture can be accurately obtained.

The run-length data encoding module 80 re-encodes the scaled run-length data and sends it to a hardware component (i.e. the displaying hardware 202), where it can be fully decoded and displayed. In this embodiment, the encoded scaled run-length data can be directly read by displaying hardware 202 for displaying the scaled sub-picture. It should be noted that the displaying hardware 202 shown in FIG. 2 includes all hardware components required to process the encoded scaled pixel data and display the scaled sub-picture.

Please note that the scaling module, encoding module, and decoding module featured in FIG. 1 and FIG. 2 are essentially software components; however, they may also be replaced by hardware components. This also obeys the spirit of the present disclosure.

By decoding the sub-picture according to a simple compression scheme, pixel information of the sub-picture can be obtained, without needing to fully decode the data. Scaling can then be performed on the decoded sub-picture utilizing predetermined algorithms, and the scaled sub-picture then re-encoded according to the simple compression scheme, so an accurately scaled sub-picture can be successfully read and displayed by a following hardware device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A firmware system for performing scaling on a sub-picture, the firmware system comprising:
a scaling module, for receiving pixel data of the sub-picture, setting a scaling factor according to the pixel data, and scaling the pixel data according to the scaling factor to generate scaled pixel data of a scaled sub-picture corresponding to the sub-picture; and
a pixel data encoding module, for encoding the scaled pixel data to generate encoded scaled pixel data of the sub-picture.

2. The firmware system of claim 1, wherein the encoded scaled pixel data can be directly read by hardware for displaying the scaled sub-picture.

3. The firmware system of claim 1, wherein the scaling module further comprises:
a vector computing module, for determining a first vector according to a source video resolution format of the sub-picture and a target video resolution format of the scaled sub-picture; and
an algorithm determining module, for determining the scaling factor according to the first vector.

4. A firmware system for performing scaling on a sub-picture, the firmware system comprising:
a pixel data decoding module, for receiving encoded pixel data of the sub-picture and decoding the encoded pixel data to generate pixel data of the sub-picture;
a scaling module, for receiving the pixel data of the sub-picture, setting a scaling factor according to the pixel data, and scaling the pixel data according to the scaling factor to generate scaled pixel data of a scaled sub-picture corresponding to the sub-picture; and
a pixel data encoding module, for encoding the scaled pixel data to generate encoded scaled pixel data of the sub-picture.

5. The firmware system of claim 4, wherein the encoded scaled pixel data can be directly read by hardware for displaying the scaled sub-picture.

6. The firmware system of claim 4, wherein the scaling module further comprises:
a vector computing module, for determining a first vector according to a source video resolution format of the sub-picture and a target video resolution format of the scaled sub-picture; and
an algorithm determining module, for determining the scaling factor according to the first vector.

7. A firmware system for performing scaling on a sub-picture, the firmware system comprising:
a scaling module, for receiving run-length data of the sub-picture, setting a scaling factor according to the run-length data, and scaling the run-length data according to the scaling factor to generate scaled run-length data of a scaled sub-picture corresponding to the sub-picture; and
a run-length data encoding module, for encoding the scaled run-length data to generate encoded scaled run-length data of the sub-picture.

8. The firmware system of claim 7, wherein the encoded scaled run-length data can be directly read by hardware for displaying the scaled sub-picture.

9. The firmware system of claim 7, wherein the scaling module further comprises:
a vector computing module, for determining a first vector according to a source video resolution format of the sub-picture and a target video resolution format of the scaled sub-picture; and
an algorithm determining module, for determining the scaling factor according to the first vector.

10. A firmware system for performing scaling on a picture, the firmware system comprising:
a run-length data decoding module, for receiving encoded run-length data of the sub-picture and decoding the encoded run-length data to generate run-length data of the sub-picture;
a scaling module, for receiving the run-length data of the sub-picture, setting a scaling factor according to the run-length data, and scaling the run-length data according to the scaling factor to generate scaled run-length data of a scaled sub-picture corresponding to the sub-picture; and
a run-length data encoding module, for encoding the scaled run-length data to generate encoded scaled run-length data of the sub-picture.

11. The firmware system of claim 10, wherein the encoded scaled run-length data can be directly read by hardware for displaying the scaled sub-picture.

12. The firmware system of claim 10, wherein the scaling module further comprises:
a vector computing module, for determining a first vector according to a source video resolution format of the sub-picture and a target video resolution format of the scaled sub-picture; and
an algorithm determining module, for determining the scaling factor according to the first vector.

13. A system for performing scaling on a sub-picture, the system comprising:
a scaling circuit, for receiving pixel data of the sub-picture, setting a scaling factor according to the pixel data, and scaling the pixel data according to the scaling factor to generate scaled pixel data of a scaled sub-picture corresponding to the sub-picture; and
a pixel data encoding circuit, for encoding the scaled pixel data to generate encoded scaled pixel data of the sub-picture.

14. The system of claim 13, wherein the encoded scaled pixel data can be directly read by hardware for displaying the scaled sub-picture.

15. The system of claim 14, wherein the scaling circuit further comprises:
a vector computing module, for determining a first vector according to a source video resolution format of the sub-picture and a target video resolution format of the scaled sub-picture; and
an algorithm determining module, for determining the scaling factor according to the first vector.

16. A system for performing scaling on a sub-picture, the system comprising:
a pixel data decoding circuit, for receiving encoded pixel data of the sub-picture and decoding the encoded pixel data to generate pixel data of the sub-picture;
a scaling circuit, for receiving the pixel data of the sub-picture, setting a scaling factor according to the pixel data, and scaling the pixel data according to the scaling factor to generate scaled pixel data of a scaled sub-picture corresponding to the sub-picture; and
a pixel data encoding circuit, for encoding the scaled pixel data to generate encoded scaled pixel data of the sub-picture.

17. The system of claim 16, wherein the encoded scaled pixel data can be directly read by hardware for displaying the scaled sub-picture.

18. The system of claim 16, wherein the scaling circuit further comprises:
a vector computing module, for determining a first vector according to a source video resolution format of the sub-picture and a target video resolution format of the scaled sub-picture; and
an algorithm determining module, for determining the scaling factor according to the first vector.

19. A system for performing scaling on a picture, the system comprising:
a scaling circuit, for receiving run-length data of the sub-picture, setting a scaling factor according to the run-length data, and scaling the run-length data according to the scaling factor to generate scaled run-length data of a scaled sub-picture corresponding to the sub-picture; and
a run-length data encoding circuit, for encoding the scaled run-length data to generate encoded scaled run-length data of the sub-picture.

20. The system of claim 19, wherein the encoded scaled run-length data can be directly read by hardware for displaying the scaled sub-picture.

21. The system of claim 19, wherein the scaling circuit further comprises:
a vector computing module, for determining a first vector according to a source video resolution format of the sub-picture and a target video resolution format of the scaled sub-picture; and
an algorithm determining module, for determining the scaling factor according to the first vector.

22. A system for performing scaling on a sub-picture, the system comprising:
a run-length data decoding circuit, for receiving encoded run-length data of the sub-picture and decoding the encoded run-length data to generate run-length data of the sub-picture;
a scaling circuit, for receiving the run-length data of the sub-picture, setting a scaling factor according to the run-length data, and scaling the run-length data according to the scaling factor to generate scaled run-length data of a scaled sub-picture corresponding to the sub-picture; and
a run-length data encoding circuit, for encoding the scaled run-length data to generate encoded scaled run-length data of the sub-picture.

23. The system of claim 22, wherein the encoded scaled run-length data can be directly read by hardware for displaying the scaled sub-picture.

24. The system of claim 22, wherein the scaling circuit further comprises:
a vector computing module, for determining a first vector according to a source video resolution format of the sub-picture and a target video resolution format of the scaled sub-picture; and
an algorithm determining module, for determining the scaling factor according to the first vector.

25. A multimedia reproducing system for performing scaling on multimedia data, the system comprising:
a decoding circuit, for receiving encoded multimedia data and decoding the encoded multimedia data to generate decoded multimedia data;
a scaling circuit, for receiving the decoded multimedia data, setting a scaling factor according to the decoded multimedia data, and scaling the decoded multimedia data according to the scaling factor to generate scaled decoded multimedia data corresponding to the multimedia data; and
an encoding circuit, for encoding the scaled decoded multimedia data to generate encoded scaled multimedia data.

26. The multimedia system of claim 25, wherein the encoded scaled multimedia data can be directly read by hardware for displaying the scaled multimedia data.

27. The system of claim 25, wherein the scaling circuit further comprises:
a vector computing module, for determining a first vector according to a source video resolution format of the multimedia data and a target video resolution format of the scaled multimedia data; and
an algorithm determining module, for determining the scaling factor according to the first vector.
